(19) United States
(12) Patent Application Publication
(10) Pub. No.: US 2011/0227406 A1
(43) Pub. Date: Sep. 22, 2011

(54) CONTROL METHOD FOR ELECTRICAL ACCUMULATOR UNIT

(76) Inventor: Vietson M. Nguyen, Rockford, IL (US)

(21) Appl. No.: 12/724,691

(22) Filed: Mar. 16, 2010

(51) Int. Cl. B60L 1/00; H02J 7/34; G06F 19/00; H02J 1/12

(52) U.S. Cl. 307/9.1; 307/48; 700/295; 307/82

(57) ABSTRACT

A power generation system has a generator, a power converter, a power bus and an electrical accumulator. The electrical accumulator stores power when the generator generates excess power and supplements power from the generator when the generator generates insufficient power.

### BACKGROUND OF THE INVENTION

The present application is directed toward power generation systems, and more particularly toward a power generation system using an electrical accumulator unit.

In order to provide power to electrical systems many vehicles, such as military aircraft, feature an on-board generator which converts rotational movement within the engines to electrical power using known power generation techniques. The generated electrical power is used to power on-board electrical components such as flight controls, sensors, or weapons controls. During standard operations, such a system will have an electrical load which normally draws power at a certain level. When some on-board electrical systems, such as weapons systems, are activated a temporary elevated load spike can occur.

In order to compensate for the temporary load spike, a generator is typically used which is rated at least as high as the highest anticipated power spike. This ensures that adequate power can be provided to the on-board electrical systems at all times, including during elevated load spikes. In a typical power generation system, the physical size of the generator is directly related to the power rating of the generator. Consequently use of a higher rated generator to account for high load spikes results in a heavy generator being required.

### SUMMARY OF THE INVENTION

Disclosed is a power generation system which has a generator, a rectifier coupled to the generator output, and a power bus which receives electrical power from the rectifier. The power bus has a connection to a variable load, and to an electrical accumulator unit. The connection to the electrical accumulator unit is configured to allow the electrical accumulator unit to both receive power from and provide power to the power bus.

Also disclosed is an electrical accumulator unit which has a pair of electrical connections for connecting to a DC power bus. The electrical accumulator unit also has a power filter connected to the DC power bus and to a DC power converter. The DC power converter connects a filter to a power storage component such that power filtered by the filter can be stored in the power storage component.

These and other features of the present invention can be best understood from the following specification and drawings, the following of which is a brief description.

### BRIEF DESCRIPTION OF THE DRAWINGS

FIG. 1 illustrates a sample aircraft having an on-board power generation system.

FIG. 2 schematically illustrates an aircraft power generation system including an electrical accumulator unit.

FIG. 3A schematically illustrates an electrical accumulator unit.

FIG. 3B schematically illustrates an example circuit which could be used in the power converter of FIG. 3A.

FIG. 4 illustrates a flowchart of an example method for operating an electrical accumulator unit in a normal mode.

### DETAILED DESCRIPTION OF THE PREFERRED EMBODIMENT

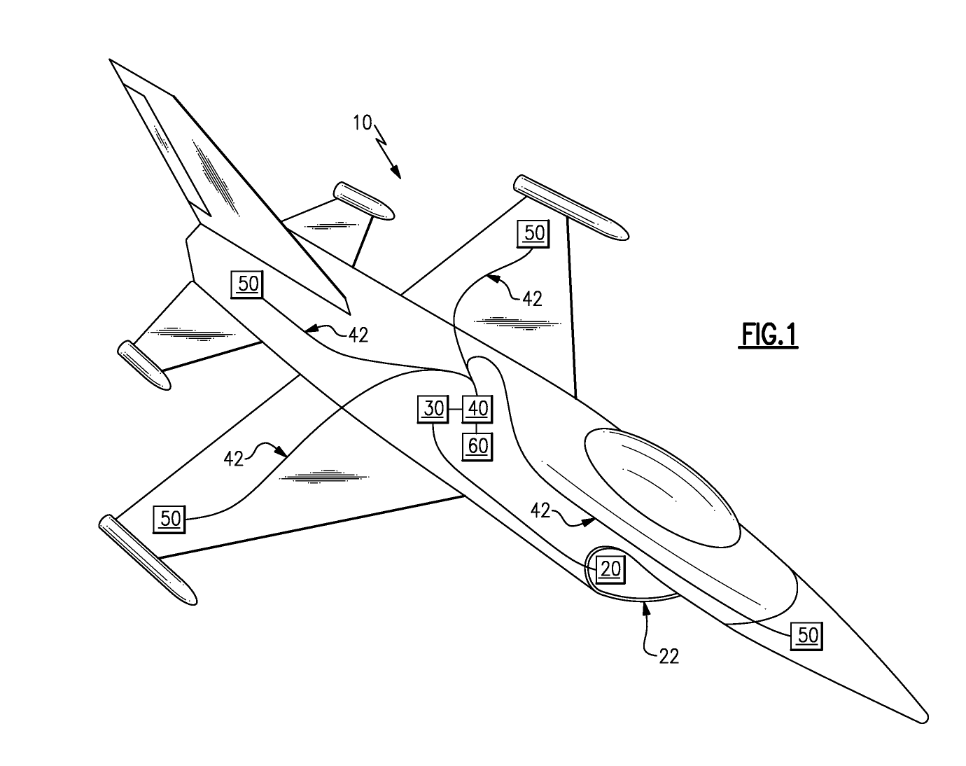

FIG. 1 schematically illustrates a sample aircraft 10 having an on-board power generation system. A generator 20 converts rotational motion within an engine 22 into electrical power using known power generation techniques. The generator 20 is electrically coupled to a rectifier 30. The rectifier 30 converts the power generated in the generator 20 (typically three-phase power) into a form usable by on-board electronics 50 (typically DC power). The rectifier 30 is electrically coupled to a power bus 40 which supplies power to the on-board electronics 50 through power supply lines 42. Additionally connected to the power bus 40, is an electrical accumulator unit 60, which can store excess power generated by the generator 20 when the load created by the on-board electronics 50 is low, and reinsert that power into the power system when the load created by the on-board electronics 50 undergoes a high load spike.

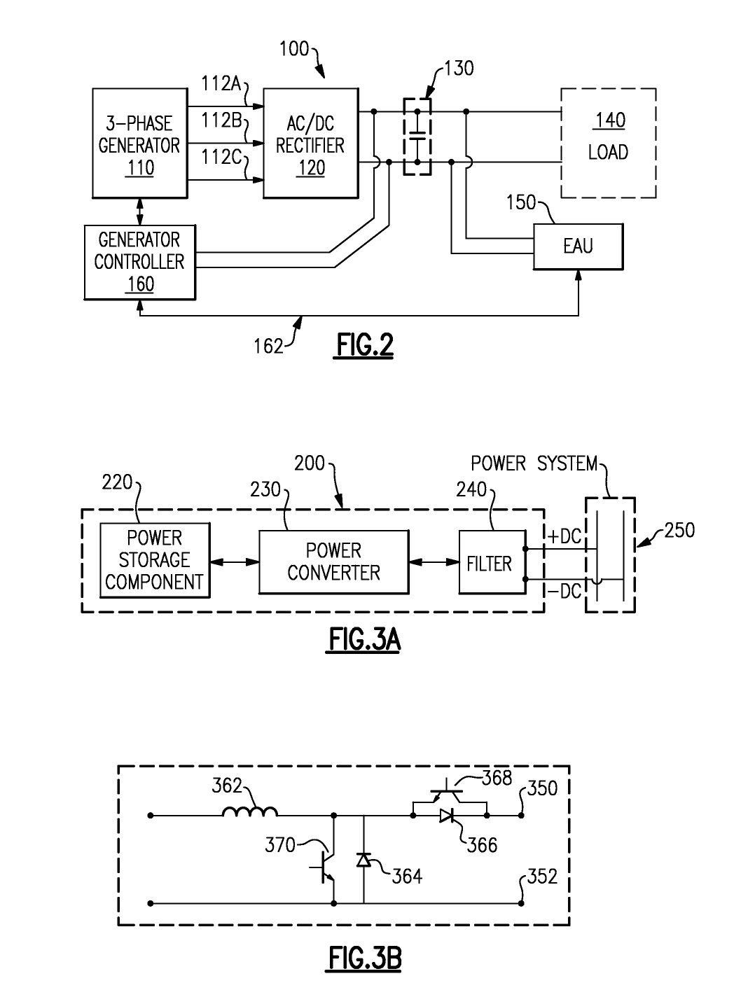

FIG. 2 schematically illustrates the power generation system described with regards to FIG. 1. A three phase generator 110 is connected to an AC/DC rectifier 120 via three phase outputs 112A, 112B, 112C. The three phase generator 110 may also be referred to as generator 110. The AC/DC rectifier 120 converts the generated three phase power into DC power, and outputs the DC power to a power bus 130. Connected to the DC power bus 130 is a variable load 140. Additionally connected to the DC power bus 130 is an electrical accumulator unit 150. The three phase generator 110, AC/DC rectifier 120, DC power bus 130, variable load 140, and electrical accumulator unit 150 represent embodiments of the generator 20, rectifier 30, power bus 40, the load created by the on-board electronics 50, and electrical accumulator unit 60 of FIG. 1 respectively. A generator controller 160 (also referred to as controller 160) is connected to both the electrical accumulator unit 150 and the three phase generator 110, and provides control signals for both. The generator controller 160 is also connected to the output of the AC/DC rectifier 120 via power sensors, and is capable of detecting the power output of the AC/DC rectifier 120 and the power demands of the variable load 140.

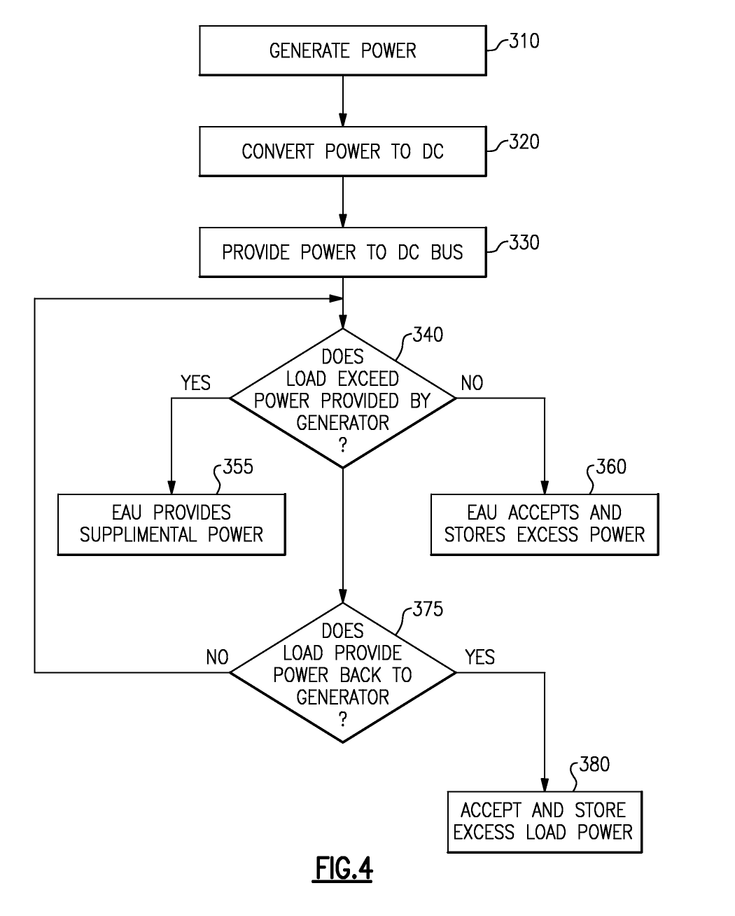

The example power generation system 100 of FIG. 2 has three modes of operation, which are controlled by the generator controller 160. The first mode is a “normal operations mode”. In the normal operations mode the generator 110 generates power at its maximum rating and the variable load 140 uses less than all of the generated power. The excess power is siphoned off by the electrical accumulator unit 150, which stores the excess power in a power storage component such as a battery or ultra capacitor. When the variable load 140 spikes, and exceeds the generating capacity of the generator 110, during normal mode, the electrical accumulator unit 150 reverses and begins supplementing the power provided to the DC power bus 130 with the power which has been stored within the power storage component, thereby ensuring that the variable load 140 receives adequate power throughout the high power spike. A step by step description of this method is described below with reference to FIG. 4.

The second mode of operation is an “emergency power mode.” The electrical accumulator unit 150 is switched to emergency power mode whenever the generator 110 unexpectedly ceases operations, or whenever instructed to switch by the generator controller 160. During emergency power mode, the electrical accumulator unit 150 provides enough electrical power to operate all essential electronics, such as flight controls, within the variable load 140 from the reserve power stored in the power storage component. In emergency mode, any non-essential electronics, such as weapons systems, are turned off and do not require power. This allows the electrical accumulator unit 150 to also operate as an emergency backup in case either the generator 110 or the engine 22 of FIG. 1 fails.

The third mode of operation for the electrical accumulator unit 150 is an “off” mode. In the off mode, the generator controller 160 switches the electrical accumulator unit 150 “off” such that it is not providing power to the DC power bus 130, or receiving power from the DC power bus 130. The “off” mode is engaged when there is a malfunction or mechanical defect causing the electrical accumulator unit 150 to act incorrectly. In order to achieve this functionality, the electrical accumulator unit 150 is electrically decoupled from the DC power bus 130.

FIG. 3A illustrates a schematic diagram of an example electrical accumulator unit 200. The electrical accumulator unit 200 and power bus 250 represent embodiments of the electrical accumulator unit 150 and DC power bus 130 of FIG. 2. The electrical accumulator unit 200 has three primary components, an energy storage unit 220, a power converter 230, and a filter 240. The filter 240 is a combination of an input ripple filter and an electromagnetic interference (EMI) filter. The input ripple filter portion of the filter 240 removes ripple currents, which have leaked onto the power bus 250 due to the presence of power electronics in the load, such as variable load 140 of FIG. 2. Similarly, the EMI filter portion of the filter 240 filters out any electromagnetic interference present on the power bus 250. Ripple currents and electromagnetic interference are common occurrences in electrical systems and result from the connection the power bus 250 has to the variable load as well as the electrical systems exposure to other sources of electrical noise. Allowing the interference and ripple currents to reach the power converter 230 is undesirable.

After passing through the filter 240, the electrical power enters a bi-directional power converter 230 where it is converted from the form of electrical power used by the power bus 250 into a form which can be accepted and stored by the power storage component 220. The bi-directional power converter 230 is also capable of converting power output from the power storage component 220 into the form used on the power bus 250 when the electrical accumulator unit 200 is providing power to the system, such as during a high load spike or while operating in emergency mode.

The power storage component 220 can be any device or component which is capable of accepting power from the power converter 230 and storing that power for later use. In the illustrated example of FIG. 3A, a battery or ultra capacitor (ultra cap) could be used. However, other power storage components could be used with minor modifications to the electrical accumulator unit 200.

FIG. 3B illustrates a more detailed example embodiment of a power converter 230, such as would be used in FIG. 3A. The power converter 230 has a high side power connector 350 and a low side power connector 352, which connect the power converter 230 to the filter 240 (illustrated in FIG. 3A). The example circuit illustrated in FIG. 3B is a bi-directional buck-boost converter which uses an inductive filter 362, a pair of diodes 364, 366 and a pair of transistors 368, 370 to reduce the voltage from the power bus 250 to a level acceptable by the power storage component 220 while power is being stored, and to raise the voltage level of the power being produced by the power storage component 220 when the power storage component 220 is providing power to the power bus 250. While the example buck-boost converter uses a single buck-boost circuit, a functionally similar circuit could be used which includes several iterations of the illustrated buck-boost circuit connected in parallel and phase shifted to work as a single unit. The inductive filter 362, diodes 364, 366 and transistors 368, 370 need not be implemented as discrete components. The transistors 368, 370 in the buck-boost circuit can be controlled by the generator controller 160 (illustrated in FIG. 2) according to known control techniques or by a central power system controller which can control other load and storage units in modern aircraft electrical power systems.

The generator controller 160 is capable of controlling the mode of the electrical accumulator unit 150 through a control wire 162, which communicatively couples the controller 160 and the electrical accumulator unit 150 as depicted in FIG. 2. The generator controller 160 can output at least three signals across the control wire 162 with each signal corresponding to one of the above listed modes of operation. For example, the first signal may be a “1” which places the electrical accumulator unit 150 in the normal mode of operations, the second signal can be a “2” which places the electrical accumulator unit 150 in the emergency mode, and the third signal can be a “0” which places the electrical accumulator unit 150 in the off mode. Alternate designations for each signal could also be used without impacting performance. The generator controller 160 additionally can control the generator's 110 typical operations using known generator control methods, without impacting the performance or control of the electrical accumulator unit 150. By way of example, a standard proportional integral (PI) control scheme could be used by a micro-controller or circuitry of controller 160 to control the power outputs of both the generator 110 and the electrical accumulator unit 150.

An additional, fourth operation mode can also be included. In the fourth operation mode, the electrical accumulator unit 150 is placed in a siphon load power mode. The electrical accumulator unit 150 is placed in this mode when the load begins to provide power back up the power system. If the power is allowed from the variable load 140 to the generator 110, the generator's performance can be negatively impacted. When the electrical accumulator unit 150 is placed in the fourth mode, any power generated by the variable load 140 which would otherwise be sent back to the generator 110 is instead siphoned off by the electrical accumulator unit 150 where it is stored in the power storage component 220.

FIG. 4 illustrates a flowchart of operations of the electrical accumulator unit 150, 200 of FIGS. 2 and 3A in the normal mode. Initially power is generated by the generator 110 in the “generate power” step 310. After the power has been generated, it is converted into a DC power format used by the DC power bus 130 in the “convert power to DC” step 320, and the power is provided to the DC power bus 130 in the “provide power to DC bus” step 330. Power conversion may be performed by the AC/DC rectifier 120 of FIG. 2. The controller 160 then determines whether the variable load 140 connected to the DC power bus 130 is currently exceeding the amount of power which can be provided by the generator 110 in the “does load exceed power provided by the generator” step 340.

If the variable load 140 exceeds the amount of power which can be generated by the generator 110, the method proceeds to the electrical accumulator unit “provides supplemental power” step 355. In the electrical accumulator unit “provides supplemental power” step 355, the electrical accumulator unit 150 provides an amount of power equal to the amount by which the variable load 140 exceeds the generation capabilities of the generator 110. The power is pulled from the power stored within the power storage component 220 of the electrical accumulator unit 150, 200 of FIGS. 2 and 3A.

If the variable load 140 does not exceed the amount of power which can be generated by the generator 110, the method moves to the electrical accumulator “accepts and stores excess power” step 360. In this step, the electrical accumulator unit 150 accepts any power generated by the generator 110 which is not required to power the variable load 140, and stores it in a power storage component for later use in either the electrical accumulator unit “provides supplemental power” step 355 or in emergency mode operations.

While the power demands of variable load 140 are being checked in the “does load exceed power provided by generator” step 340, an additional step may be performed. The “does load provide power back to the generator” step 375 checks to see if the variable load 140 is generating power such that electrical power will be transmitted back through the electrical system to the generator 110. If the variable load 140 is not generating power, the method proceeds as described above. If the variable load 140 is generating power, then the electrical accumulator unit 150 accepts and stores the power generated by the variable load 140 in and “accept and store excess load power” step 380. The “accept and store excess load power” step 380 operates in much the same manner as the “accept and store excess power” step 360.

Although an example embodiment has been disclosed, a worker of ordinary skill in this art would recognize that certain modifications would come within the scope of this invention. For that reason, the following claims should be studied to determine the true scope and content of this invention.

What is claimed is:

1. An aircraft power generation system comprising;
a generator;
a rectifier electrically coupled to an output of said generator;
a power bus connected to said rectifier such that said power bus receives electrical power from said rectifier;
said power bus comprising a load connection capable of connecting to an external load, and thereby providing power to said external load; and
an electrical accumulator unit connected to said power bus such that said electrical accumulator unit is capable of storing power from said power bus and providing power to said power bus.

2. The aircraft power generation system of claim 1, wherein said electrical accumulator unit comprises a power storage component, a power converter component, and a power filter.

3. The aircraft power generation system of claim 2, wherein said power storage component comprises an ultra capacitor.

4. The aircraft power generation system of claim 2, wherein said power storage component comprises a high voltage battery.

5. The aircraft power generation system of claim 2, wherein said power converter comprises a buck-boost converter.

6. The aircraft power generation system of claim 5, wherein said buck-boost converter comprises a plurality of buck-boost converters arranged in a parallel, phase shifted arrangement.

7. The aircraft power generation system of claim 1, wherein said electrical accumulator unit is electrically and controllably coupled to a controller, such that said controller is capable of setting an operational mode of said electrical accumulator unit.

8. The aircraft power generation system of claim 7, wherein said controller comprises a proportional integral controller.

9. The aircraft power generation system of claim 7, wherein said electrical accumulator unit comprises at least a first normal operations mode, a second emergency operations mode, and a third off operations mode.

10. The aircraft power generation system of claim 9, wherein said electrical accumulator unit comprises a fourth siphon load power operations mode.

11. An electrical accumulator unit comprising:
a pair of electrical connectors for coupling the electrical accumulator unit to a DC power bus;
a power filter connected to said electrical connectors, and to a power converter; and
said power converter connecting said power filter to a power storage component such that power filtered by said power filter can be stored in said power storage component.

12. The electrical accumulator unit of claim 11, wherein said power filter comprises a ripple filter component and an electromagnetic interference filter component.

13. The electrical accumulator unit of claim 11, wherein said power converter comprises a buck-boost converter circuit.

14. The electrical accumulator unit of claim 13, wherein said buck-boost converter circuit comprises a plurality of parallel, phase shifted, buck-boost converter circuits configured to operate in conjunction with each other.

15. A method for operating an aircraft power system comprising the steps of:
generating power with a three-phase generator;
converting said power into DC power format;
providing said DC power to a DC power bus; and
said DC power bus providing power to a variable load and to an electrical accumulator unit.

16. The method of claim 15, further comprising the step of said electrical accumulator unit accepting and storing power from said DC power bus when power generated in said step of generating power exceeds an amount of power needed by said variable load.

17. The method of claim 16, further comprising the step of said electrical accumulator unit providing stored power to said DC power bus whenever said variable load exceeds an amount of power generated by said generator.

18. The method of claim 15, further comprising the step of controlling said electrical accumulator unit using a proportional integral control scheme stored on a micro-controller.

19. The method of claim 15, wherein said electrical accumulator unit is operated in one of a mode chosen from the list of a normal mode, an emergency mode, and an off mode.

20. The method of claim 19, wherein said normal mode comprises said electrical accumulator unit storing excess energy from said DC power bus when said variable load is at a normal level and providing excess energy to said DC power bus when said variable load is at an elevated level, said emergency mode comprises said electrical accumulator unit providing energy to said DC power bus at all times, and said off mode comprising said electrical accumulator unit being electrically disconnected from said DC power bus.
